(19) United States
(12) Patent Application Publication
(10) Pub. No.: US 2020/0261968 A1
(43) Pub. Date: Aug. 20, 2020

(54) DEVICE FOR FORMING AND INSPECTING END PIECE ON SCREW OF FASTENING RING

(71) Applicant: Chih-Feng Lai, CHANGHUA COUNTY (TW)

(72) Inventor: Chih-Feng Lai, CHANGHUA COUNTY (TW)

(21) Appl. No.: 16/278,735

(22) Filed: Feb. 19, 2019

(51) Int. Cl. B21J 15/36; B21J 15/32; B21J 15/12; B23P 19/00; B23P 19/10

(52) U.S. Cl. CPC B21J 15/36; B21J 15/32; B23P 19/105; B23P 19/002; B21J 15/12

(57) ABSTRACT

A device for forming and inspecting an end piece on a screw of a fastening ring includes a deck with a rotary disk, a control unit for driving the rotary disk, an inspection unit, a first riveting machine, an arm unit and a conveyor respectively and electrically connected to the control unit. The inspection unit, the first riveting machine, the arm unit and the conveyor are located around the rotary disk. Multiple holding devices are connected to the rotary disk and each holding device holds two fastening rings. The screw of each fastening ring is formed with an end piece by the first riveting machine, the arm unit and the conveyor. The inspection unit inspect the formation of the end piece and classifies defective products and non-defective products.

### BACKGROUND OF THE INVENTION

### 1. Fields of the Invention

The present invention relates to a device for forming and inspecting an end piece on the screw of a fastening ring.

### 2. Descriptions of Related Art

The conventional fastening rings 90 as shown in FIG. 16 includes an opening 91 which is formed between two adjustment plates 92, and a screw 93 is threadedly extended through the two adjustment plates 92 to clamp a hose or the like. When in manufacturing, the fastening ring 90 is positioned at a post “A1” of a riveting machine “A”, and the threaded section 931 of the screw 93 is orientated upward as disclosed. The rotatable member “A2” of the riveting machine “A” is lowered and machines the distal end of the threaded section 931 to be an end piece 932 as shown in FIG. 17.

As shown in FIG. 16, the heads 932 formed on the threaded section 931 of the fastening rings 90 is mainly operated by manual way. The manufacturers hold and position the fastening rings 90 to the post “A1”, and position the threaded section 931 to be upright, then the manufacturers control the rotatable member “A2” to descend and to form the threaded section 931 with the end piece 932.

It is noted that there is no proper positioning device to help the manufacturers to position the fastening rings 90 so that the manufacturers have to hold the fastening rings 90 stably to ensure that the rotatable member “A2” is precisely to form an end piece 932 on the distal end of the threaded section 931. However, the manufacturers have to use the other hand to operate switches to control the rotatable member “A2” to move toward the threaded section 931. A slight swing or shift of the manufacturers' body may cause the screws 93 and the fastening rings 90 offset from the desired position.

As shown in FIG. 18, when the screw 93 of the fastening ring 90 is not properly positioned on the post “A1”, the threaded section 931 extends an angle relative to a vertical direction so that when the rotatable member “A2” is moved toward the threaded section 931, the end piece 932 is inclined and deformed, and is a defective product as shown in FIG. 18.

The present invention intends to provide a device for automatically and precisely forming and inspecting an end piece on a screw of a fastening ring.

### SUMMARY OF THE INVENTION

The present invention relates to a device for forming and inspecting an end piece on a screw of a fastening ring, and the device comprises a deck having a rotary disk connected thereon, and a control unit is connected to the deck and controls the rotary disk. An inspection unit, a first riveting machine, an arm unit and a conveyor are respectively and electrically connected to the control unit, and located around the rotary disk. Multiple holding devices are connected to the rotary disk and each holding device includes two holding members, and each holding member holds a fastening ring. Each fastening ring has an opening defined between two plates, and a screw extends through the two plates. The screw has a threaded section which extends upward. The screw is positioned by the holding member corresponding thereto.

The inspection unit has an inspection rod which descends and contacts the threaded section of the screw of the fastening ring on the holding member of the holding device corresponding thereto so as to inspect the screw. When the screw is located at a correct position, the inspection unit sends a normal signal to the control unit which drives the rotary disk to rotate. When the screw is located at an incorrect position, the inspection unit sends an abnormal signal to the control unit which stops the rotary disk.

The first riveting machine includes a first rotatable member which is located corresponding to one of the fastening rings of one of the holding devices. The control unit controls the first rotatable member to descend and to machine the threaded section of the fastening ring corresponding thereto. The control unit then controls the rotary disk to rotate and aligns another one of the fastening ring with the first rotatable member, and controls the first rotatable member to descend and to machine the threaded section of the fastening ring corresponding thereto.

The arm unit extends across the rotary disk and the conveyor. The arm unit picks one of the fastening ring and releases the fastening ring to the conveyor.

Preferably, a second riveting machine is located between the first riveting machine and the arm unit. The second riveting machine includes a second rotatable member which is located corresponding to one of the holding device. The control unit controls the first riveting machine to machine the threaded section of the screw of one of the fastening rings, and the control unit controls rotary disk to rotate to align the second rotatable member with another one of the fastening rings of the holding device, and controls the second riveting machine to machine the threaded section of the screw of another one of the fastening rings.

Preferably, the holding devices each have a first step, a second step, two lateral sides and two guide plates. The first and second steps are located between the two lateral sides. The first step is higher than the second step. The two guide plates are connected to the two lateral sides. The fastening ring is restricted between the two guide plates and rested on the second step. The screw of the fastening ring is rested on the second step which includes a restriction recess in which a head of the screw is accommodated.

Preferably, the inspection unit includes a first post, two descending members, two control members, two lights and two cylinders. The first post includes a fixing member on the top thereof. The descending members and the control members are connected to two sides of the fixing member. The descending members are connected to the two inspection rods respectively. The control members are electrically connected to the lights, the cylinders and the control unit. The inspection rods each include a pre-set travel value from an initial position to a final position where the screw of the fastening ring on the holding device is located. When each cylinder drives the inspection rod downward to travel from the initial position to the final position, and the travel meets the pre-set travel value, the control member sends a normal signal to the control unit and the light emits a first color light. The control unit receives the normal signal and rotates the rotary disk to bring the fastening ring on the holding device to be treated by the first riveting machine and the arm unit. When each cylinder drives the inspection rod downward to travel from the initial position to the final position, and the travel does not meet the pre-set travel value, the control member sends an abnormal signal to the control unit and the light emits a second color light. The control unit receives the abnormal signal and stops the rotary disk.

Preferably, the arm unit includes a second post, a transverse movement member and two claws. The transverse movement member is connected to the upper section of the second post. The two claws are connected to the transverse movement member and located corresponding to one of the holding device. The control unit controls the two claws to descend and to clamp the two fastening rings on the holding device. The transverse movement member drives the two claws to across the rotary disk and the conveyor, and to release the fastening rings to the conveyor.

Preferably, the control unit controls the two claws to release the two fastening rings in sequence so that the two fastening rings do not hit each other.

Preferably, a classification unit is located at the exit of the conveyor and includes a dispensing disk, an inspection member, a non-defective product area and a defective product area. The dispensing disk accepts the fastening rings from the conveyor. The inspection member is located above the dispensing disk and inspects the fastening rings on the dispensing disk. The fastening rings on the dispensing disk are collected to the non-defective product area and the defective product area.

Preferably, the non-defective product area and the defective product area are located around the dispensing disk and separated from a distance. The classification unit includes a first blowing member and a second blowing member, wherein the first and second blowing members are located above the dispensing disk. The first blowing member faces the non-defective product area, and the second blowing member faces the non-defective product area. The control unit is electrically connected to the dispensing disk, the inspection member, the first blowing member and the second blowing member.

Preferably, the dispensing disk is located below the exit of the conveyor so as to accept the fastening rings drop from the conveyor. The inspection member is a ccd image detector and located above the dispensing disk. The control unit controls the inspection member to take images from the fastening rings on the dispensing disk and to check the screws of the fastening rings. The inspection member sends signals of defective products or signals of non-defective products to the control unit. The control unit controls the first blowing member to blow the fastening rings accompanied with signals of non-defective product to the non-defective product area. The control unit controls the second blowing member to blow the fastening rings accompanied with the signals of defective product to the defective product area.

Preferably, the defective product area includes a first grade defective product area, a second grade defective product area and a double check area. The signals of defective product includes three different signals of defective product sent to the control unit, the control unit controls the second blowing member to respectively blow the fastening rings according to the three signals of defective product to the first grade defective product area, the second grade defective product area and the double check area. The present invention will become more apparent from the

following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the device of the present invention;

FIG. 2 is a plane view to show the device of the present invention;

FIG. 3 shows the fastening ring and the holding device of the device of the present invention;

FIG. 4 shows the inspection unit of the device of the present invention;

FIG. 5 shows that the inspection unit of the device of the present invention is lowered to inspect the fastening ring;

FIG. 6 is another view to show that the inspection unit of the device of the present invention is lowered to inspect the fastening ring;

FIG. 7 is a front view of the first riveting machine of the device of the present invention;

FIG. 8 shows that the first riveting machine of the device of the present invention is lowered to form the end piece to the screw of the fastening ring;

FIG. 9 shows the second riveting machine of the device of the present invention;

FIG. 10 shows the arm unit of the device of the present invention;

FIG. 11 shows that the arm unit is lowered to pick the fastening rings;

FIG. 12 shows that fastening rings are picked by the arm unit;

FIG. 13 shows that the arm unit is raised with the fastening rings picked by the arm unit;

FIG. 14 shows that the arm unit moves to a position above the conveyor;

FIG. 15 shows the classification unit of the device of the present invention;

FIG. 16 shows the manual way to position the fastening ring relative to the rotatable member of the riveting machine;

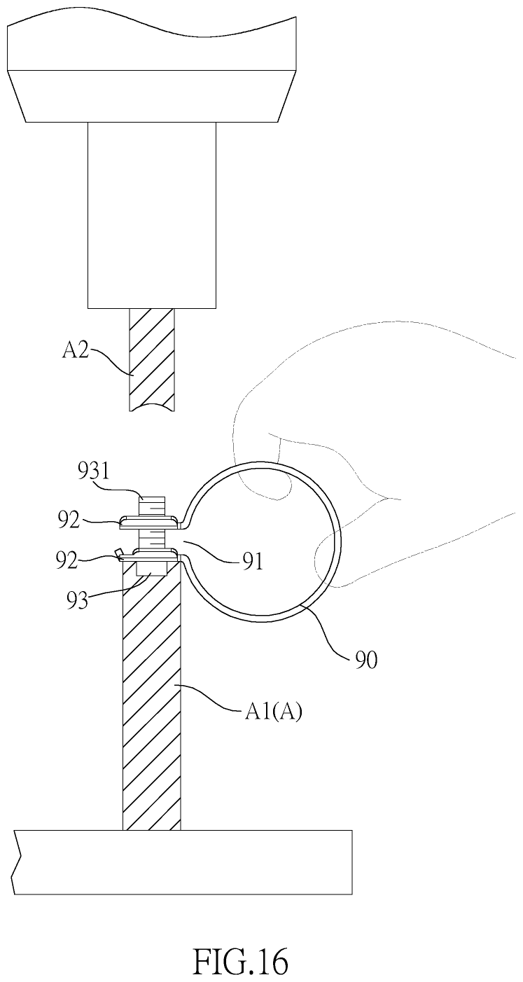

FIG. 17 shows that the rotatable member of the riveting machine is rotatably engaged with the screw of the fastening ring, and

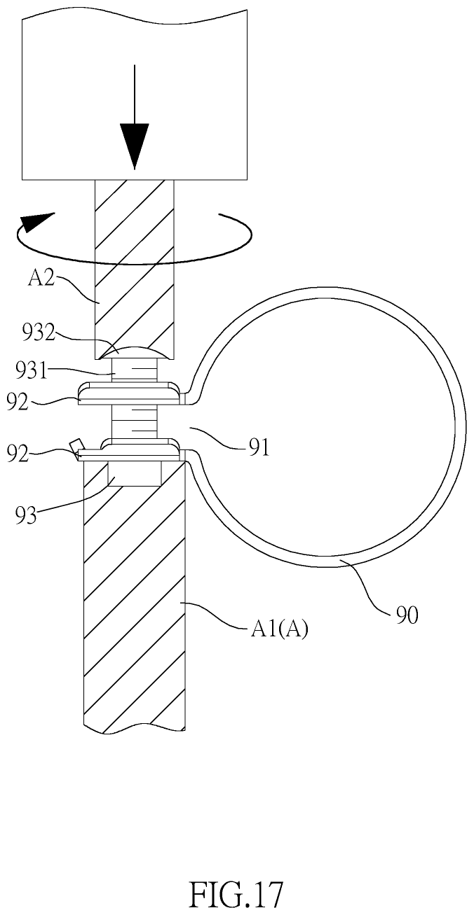

FIG. 18 shows that the fastening ring becomes a defective product by the conventional manual way.

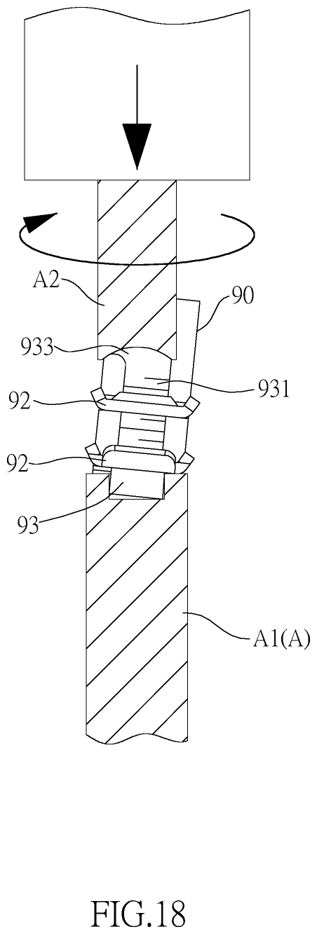

### DETAILED DESCRIPTION OF THE PREFERRED EMBODIMENT

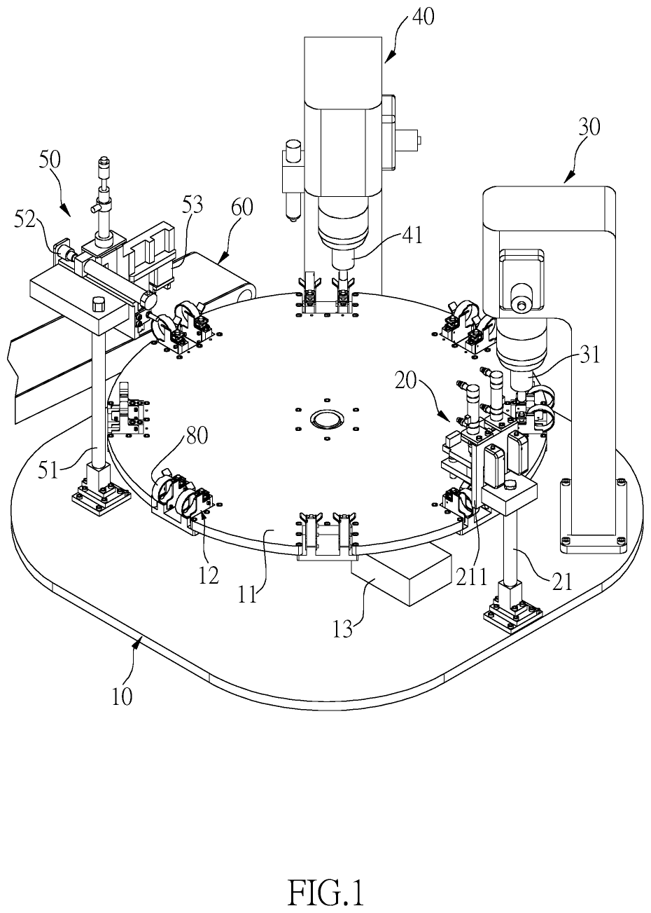

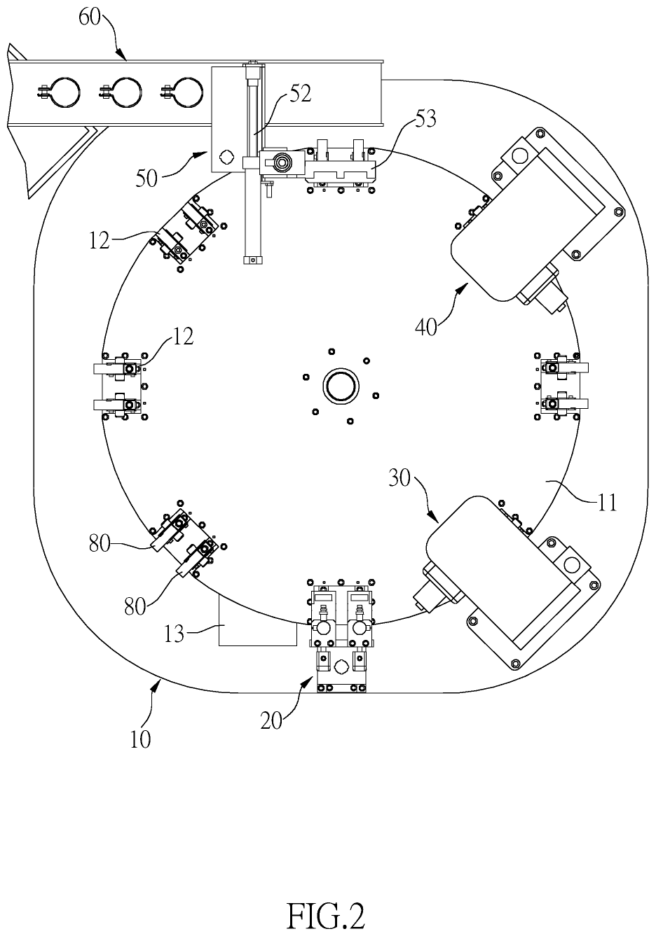

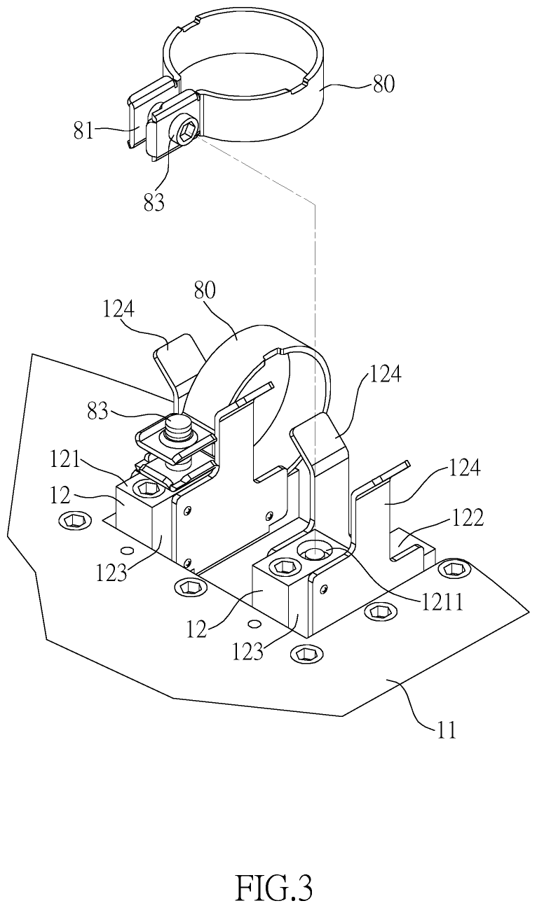

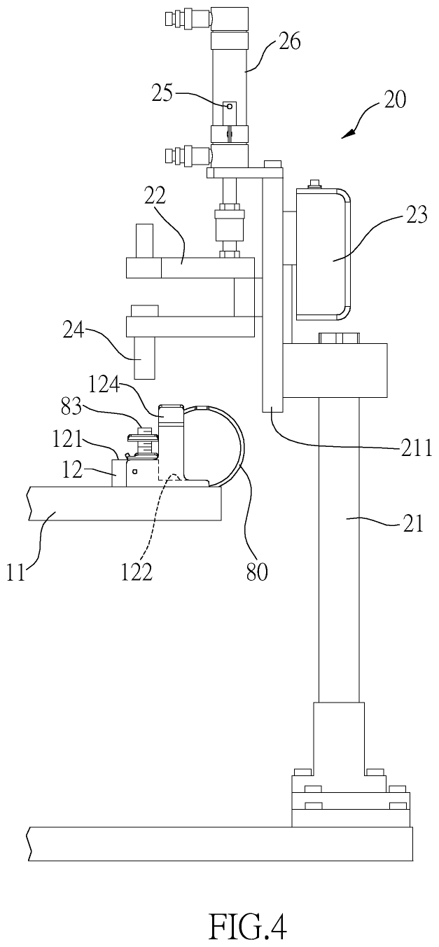

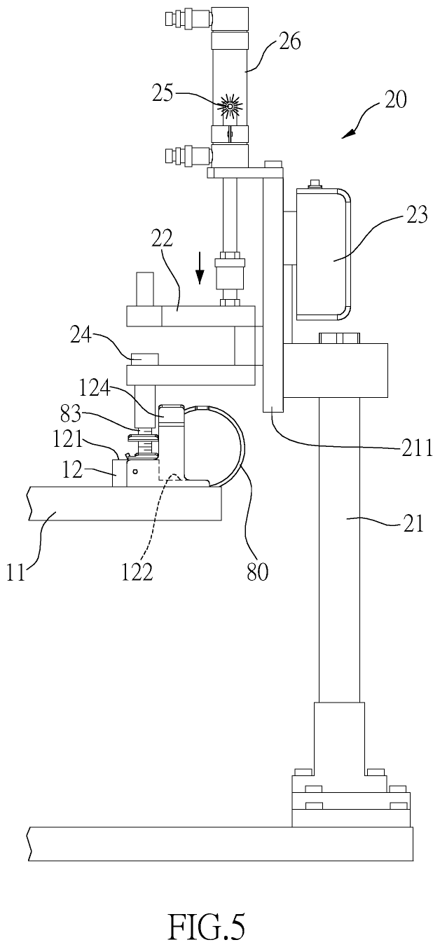

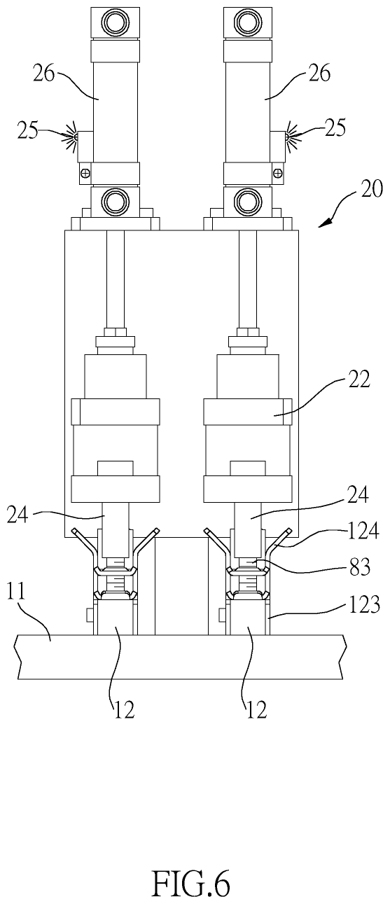

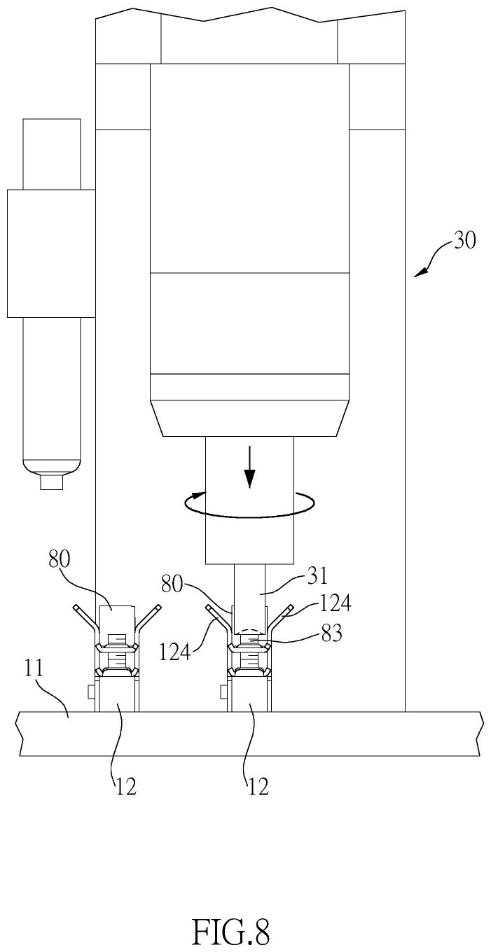

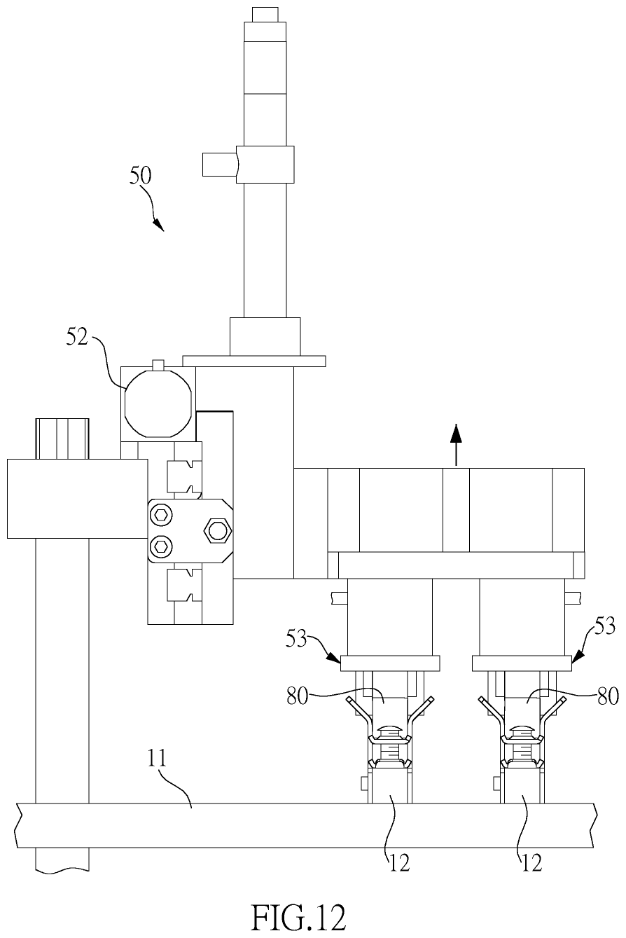

Referring to FIGS. 1 to 15, the device for forming and inspecting an end piece on a screw of a fastening ring of the present invention comprises a deck 10 and a rotary disk 11 is connected on the deck 10. A control unit 13 is connected to the deck 10 and controls the rotary disk 11 to rotate. An inspection unit 20, a first riveting machine 30, an arm unit 50 and a conveyor 60 are respectively and electrically connected to the control unit 13, and located around the rotary disk 11. Multiple holding devices 12 are connected to the rotary disk 11 and each holding device 12 includes two holding members, and each holding member holds a fastening ring 80. Each fastening ring 80 has an opening 81 defined between two plates, and a screw 83 extends through the two plates. The screw 83 is positioned by the holding member corresponding thereto. The screw 83 includes a head rested on the holding device 12, and a threaded section 831 which extends upward.

The inspection unit 20 has an inspection rod 24 which descends and contacts the threaded section 831 of the screw 83 of the fastening ring 80 one of the holding members of the holding device 12 corresponding thereto so as to inspect the screw 83. When the screw 83 is located at a correct position, the inspection unit 20 sends a normal signal to the control unit 13 which drives the rotary disk 11 to rotate. Therefore, the fastening ring 80 will be processed in sequence by the first riveting machine 20 and the arm unit 50. On the contrary, when the screw 83 is located at an incorrect position, the inspection unit 20 sends an abnormal signal to the control unit 13 which stops the rotary disk 11.

The first riveting machine 30 includes a first rotatable member 31 which is located corresponding to one of the fastening rings 80 of one of the holding devices 12. The control unit 13 controls the first rotatable member 31 to descend and to machine the threaded section 831 of the fastening ring 80 corresponding thereto. Therefore, an enlarged end piece 832 is formed at the distal end of the threaded section 831 by the first rotatable member 31. The control unit 13 then controls the rotary disk 11 to rotate and aligns another one of the fastening ring 80 with the first rotatable member 31, and controls the first rotatable member 31 to descend and to machine the threaded section 831 of the fastening ring 80 corresponding thereto.

The arm unit 50 extends across the rotary disk 11 and the conveyor 60. The arm unit 50 picks one of the fastening ring 80 and releases the fastening ring 80 to the conveyor 60.

A second riveting machine 40 is located between the first riveting machine 30 and the arm unit 50. The second riveting machine 40 includes a second rotatable member 41 which is located corresponding to one of the holding device 12. The control unit 13 controls the first riveting machine 30 to machine the threaded section 831 of the screw 83 of one of the fastening rings 80, and the control unit 13 controls rotary disk 11 to rotate to align the second rotatable member 40 with another one of the fastening rings 80 of the holding device 12, and then controls the second riveting machine 40 to machine the threaded section 831 of the screw 83 of another one of the fastening rings 80. The arm unit 50 includes a second post 51, a transverse movement member 52 and two claws 53. The transverse movement member 52 is connected to the upper section of the second post 51. The two claws 53 arc connected to the transverse movement member 52 and located corresponding to one of the holding devices 12. The control unit 13 controls the two claws 53 to descend and to clamp the two fastening rings 80 on the holding device 12 corresponding thereto. The transverse movement member 52 drives the two claws 53 to across the rotary disk 11 and the conveyor 60, and to release the fastening rings 80 to the conveyor 60.

A classification unit 70 is located at the exit of the conveyor 60 and includes a dispensing disk 71, an inspection member 72, a non-defective product area 73 and a defective product area 74. The dispensing disk 71 accepts the fastening rings 80 delivered from the conveyor 60. The inspection member 72 is located above the dispensing disk 71 and inspects the fastening rings 80 on the dispensing disk 71. The fastening rings 80 on the dispensing disk 71 are collected to the non-defective product area 73 and the defective product area 74. the non-defective product area 73 and the defective product area 74 are located around the dispensing disk 71 and separated from a distance. Specifically, the classification unit 70 includes a first blowing member 75 and a second blowing member 76, wherein the first and second blowing members 75, 76 are located above the dispensing disk 71. The first blowing member 75 faces the non-defective product area 73, and the second blowing member 76 faces the non-defective product area 74. The control unit 13 is electrically connected to the dispensing disk 71, the inspection member 72, the first blowing member 75 and the second blowing member 76.

The holding devices 12 each have a first step 121, a second step 122, two lateral sides 123 and two guide plates 124. The first and second steps 121, 133 are located between the two lateral sides 123. The first step 121 is higher than the second step 122. The two guide plates 124 are connected to the two lateral sides 123. The fastening ring 80 is restricted between the two guide plates 124 and rested on the second step 122. The screw 83 of the fastening ring 80 is rested on the second step 121 which includes a restriction recess 1211 in which a head of the screw 83 is accommodated.

As shown in FIGS. 1 to 6, when in operation, the users put a fastening ring 80 to each holding member of the holding devices 12, and the fastening ring 80 is restricted and positioned by the guide plates 124. The fastening ring 80 rested on the second step 122. The screw 83 of the fastening ring 80 is rested on the second step 121 which includes a restriction recess 1211 in which the head of the screw 83 is accommodated.

Preferably, the inspection unit 20 includes a first post 21, two descending members 22, two control members 23, two lights 25 and two cylinders 26. The first post 21 includes a fixing member 211 on the top thereof. The descending members 22 and the control members 23 are connected to two sides of the fixing member 211. The descending members 22 are connected to the two inspection rods 24 respectively. The control members 23 are electrically connected to the lights 25, the cylinders 26 and the control unit 13. The inspection rods 24 each include a pre-set travel value from an initial position to a final position where the screw 83 of the fastening ring 80 on the holding device 12 is located. When each cylinder 26 drives the inspection rod 24 downward to travel from the initial position to the final position, and the travel meets the pre-set travel value, the control member 23 sends a normal signal to the control unit 13 and the light 25 emits a first color light. The control unit 13 receives the normal signal and rotates the rotary disk 11 to bring the fastening ring 80 on the holding device 12 to be treated by the first riveting machine and the arm unit 50. When each cylinder 26 drives the inspection rod 24 downward to travel from the initial position to the final position, and the travel does not meet the pre-set travel value, the control member 23 sends an abnormal signal to the control unit 13 and the light 25 emits a second color light. The control unit 13 receives the abnormal signal and stops the rotary disk 11. For example, assume the pre-set travel value is 10 mm, when the travel of the inspection rod 24 is less than 10 mm, such as 9.9 mm or 9.8 mm, it means that the screw 23 of the fastening ring 80 is not properly oriented with the threaded section 831 extends upward. The control unit 13 receives the abnormal signal and the rotary disk 11 is stopped by the control unit 13. The uses can re-set the fastening ring 80 and repeat the same process again. If the control unit 13 receives a normal signal, then the rotary disk 11 rotates to align the inspection rods 24 with another holding device 12.

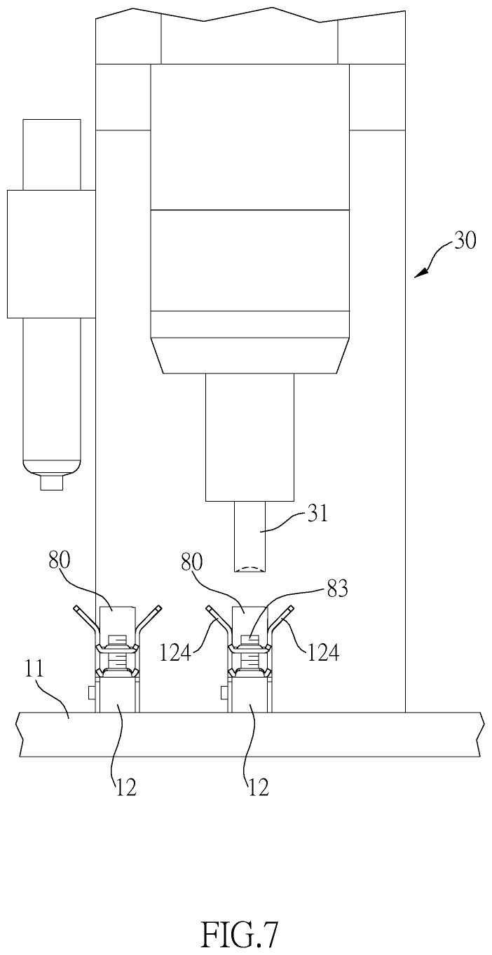

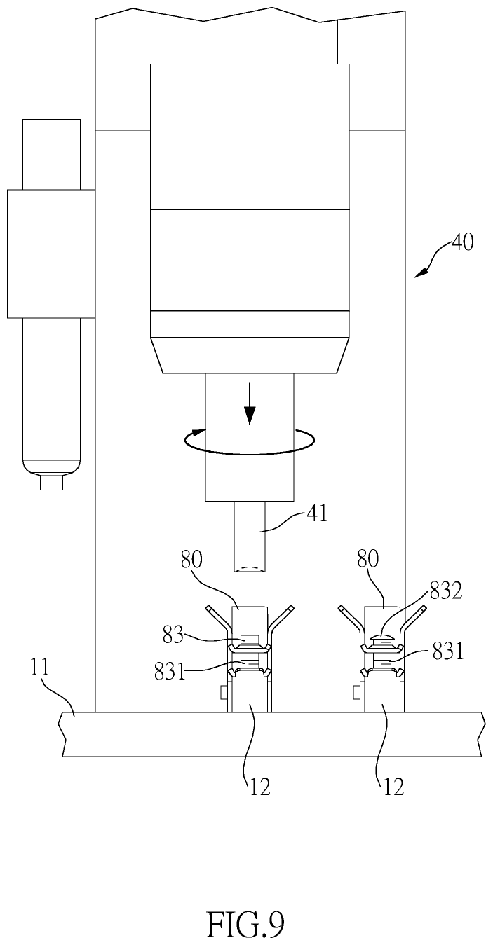

As shown in FIGS. 7 to 9, when the holding device 12 has the fastening rings 80 that are properly installed and located corresponding the first riveting machine 30, the control unit 13 controls the first rotatable member 31 to descend and form an end piece 832 at the distal end of the threaded section 831 of the screw 83. The rotary disk 11 then rotates to align the other fastening ring 80 with the second riveting machine 40. The control unit 13 controls the second rotatable member 41 of the second riveting machine 40 to descend along the arrow head in FIG. 9 to form another end piece 832 at the distal end of the threaded section 831 of the screw 83. The rotary disk 11 rotates again to align the two fastening rings 80 with the arm unit 50.

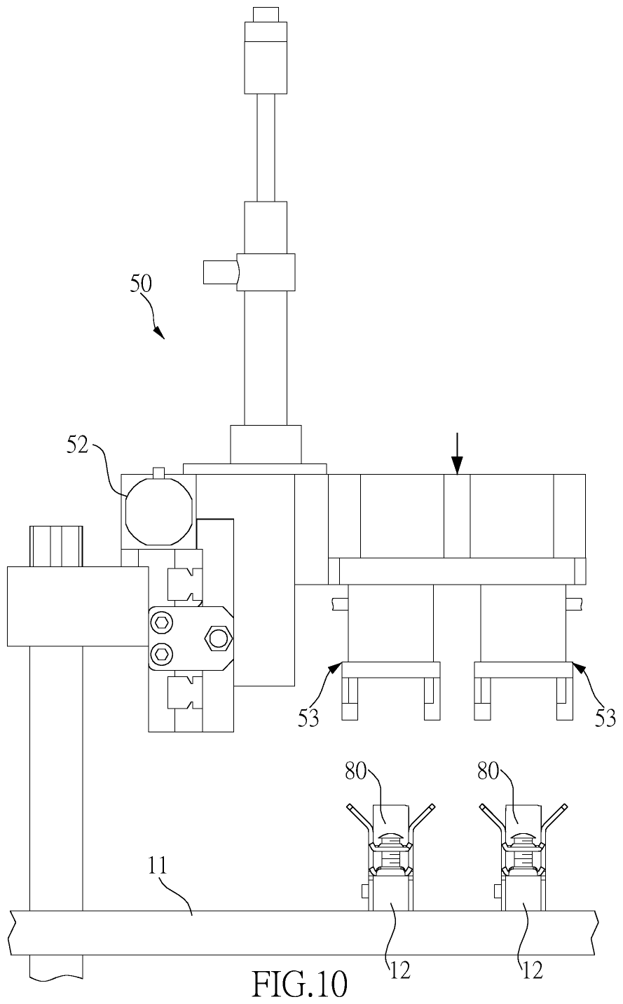

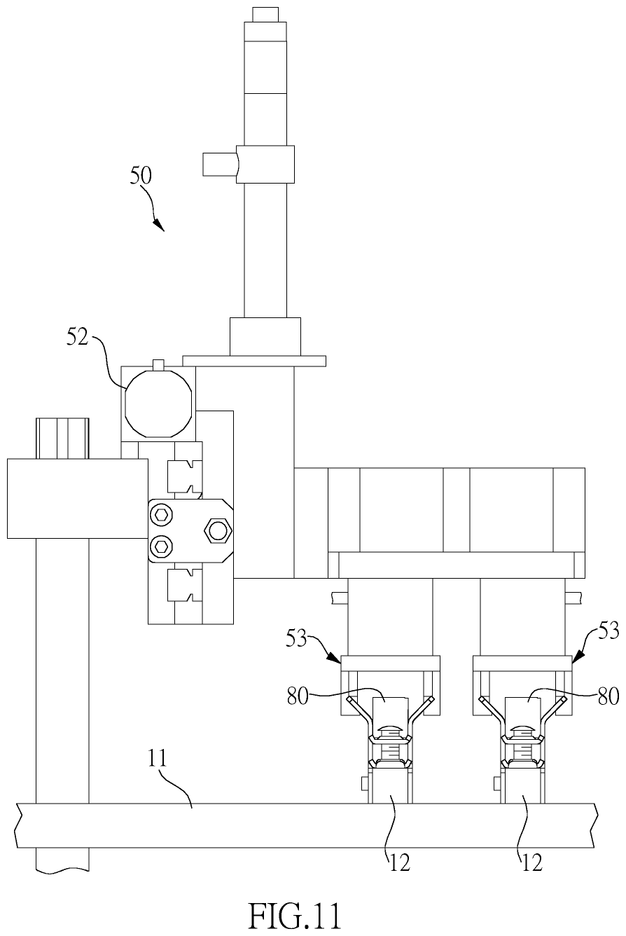

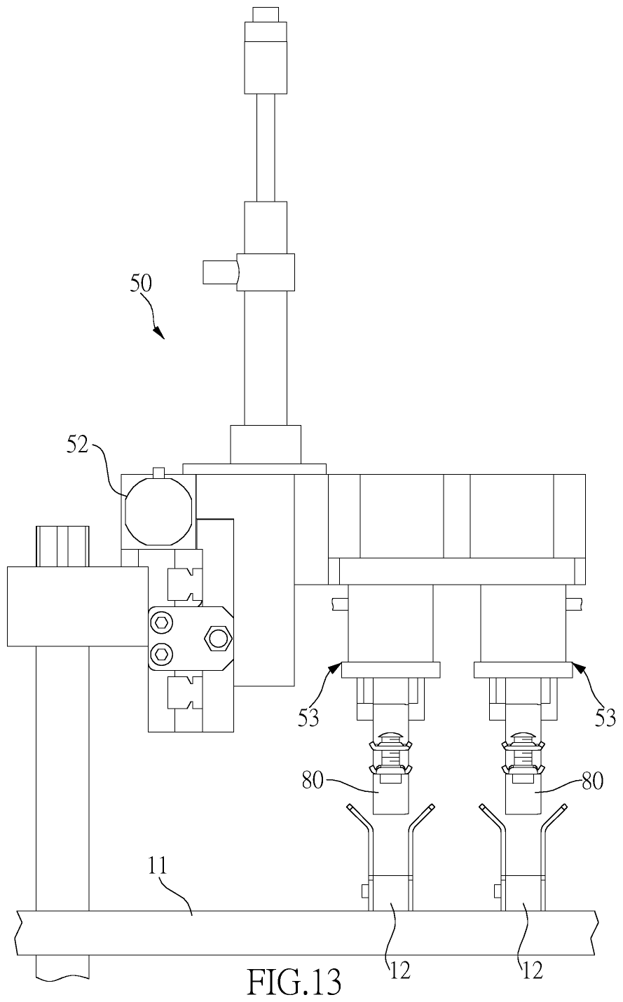

As shown in FIGS. 10 to 13, the control unit 13 controls the two claws 53 to descend to the position as disclosed in FIG. 11, and then control the two claws 53 to pick the two fastening rings 80 and move upward as shown in FIG. 13.

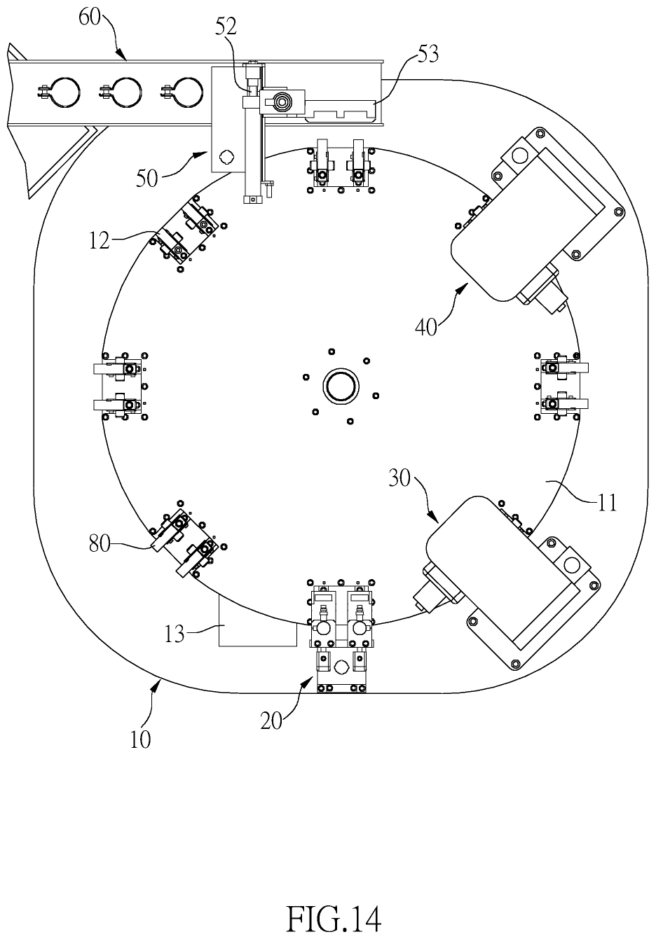

As shown in FIG. 14, the control unit 13 controls the transverse movement member 52 of the arm unit 50 to bring the two claws 53 across the rotary disk 11 and located above the conveyor 60. The control unit 13 controls the two claws 53 to release the two fastening rings 80 in sequence so that the two fastening rings 80 do not hit each other.

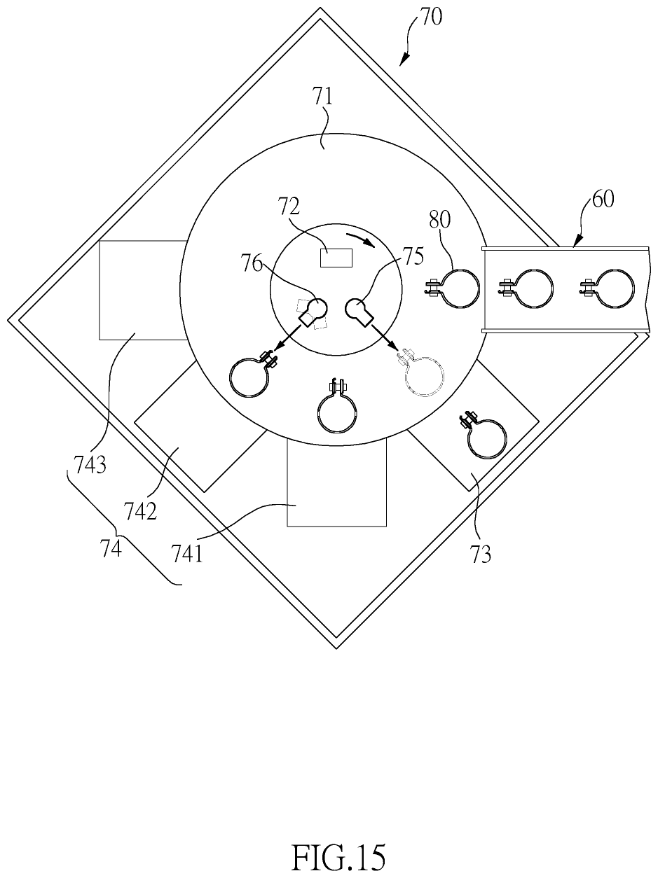

As shown in FIG. 15, the dispensing disk 71 is located below the exit of the conveyor 60 so as to accept the fastening rings 80 drop front the conveyor 60. The inspection member 72 is a cod image detector and located above the dispensing disk 71. The control unit 13 controls the inspection member 72 to take images from the fastening rings 80 on the dispensing disk 71 and to check the screws 83 of the fastening rings 80. The inspection member 72 sends signals of defective products or signals of non-defective products to the control unit 13. The control unit 13 controls the First blowing member 75 to blow the fastening rings 80 accompanied with signals of non-defective product along the direction illustrated by the arrow head to the non-defective product area 73 (as shown by solid lines and dotted lines). The control unit 13 controls the second blowing member 76 to blow the fastening rings 80 accompanied with the signals of defective product to the defective product area 74. The defective product area 74 includes a first grade defective product area 74, a second grade defective product area 74 and a double check area 743. The signals of defective product includes three different signals of defective product sent to the control unit 13, the control unit 13 controls the second blowing member 76 to respectively blow the fastening rings 80 according to the three signals of defective product to the first grade defective product area 74, the second grade defective product area 74 and the double check area 743.

The present invention provides a device that forms the end piece on the screws 83 of the fastening rings 80 and inspects the positioning of the fastening rings 80 so as to increase the efficiency of the processes. The fastening rings 80 are classified and collected automatically.

While we have shown and described the embodiment in accordance with the present invention, it should be clear to those skilled in the art that further embodiments may be made without departing from the scope of the present invention.

What is claimed is:

1. A device for forming and inspecting an end piece on a screw of a fastening ring, comprising:
a deck having a rotary disk connected thereon, a control unit connected to the deck and controlling the rotary disk, an inspection unit, a first riveting machine, an arm unit and a conveyor respectively and electrically connected to the control unit, and located around the rotary disk, multiple holding devices connected to the rotary disk and each holding device including two holding members, each holding member holding a fastening ring, each fastening ring having an opening defined between two plates, and a screw extending through the two plates, each screw having a threaded section which extends upward, the screw being positioned by the holding member corresponding thereto;
the inspection unit having an inspection rod which descends and contacts the threaded section of the screw of the fastening ring on the holding member of the holding device corresponding thereto so as to inspect the screw, when the screw is located at a correct position, the inspection unit sends a normal signal to the control unit which drives the rotary disk to rotate, when the screw is located at an incorrect position, the inspection unit sends an abnormal signal to the control unit which stops the rotary disk;
the first riveting machine including a first rotatable member which is located corresponding to one of the fastening rings of one of the holding devices, the control unit controlling the first rotatable member to descend and to machine the threaded section of the fastening ring corresponding thereto, the control unit then controlling the rotary disk to rotate and aligning another one of the fastening ring with the first rotatable member, and controlling the first rotatable member to descend and to machine the threaded section of the fastening ring corresponding thereto, and
the arm unit extending across the rotary disk and the conveyor, the arm unit picking one of the fastening ring and releasing the fastening ring to the conveyor.

2. The device as claimed in claim 1, wherein a second riveting machine is located between the first riveting machine and the arm unit, the second riveting machine includes a second rotatable member which is located corresponding to one of the holding device, the control unit controls the first riveting machine to machine the threaded section of the screw of one of the fastening rings, and the control unit controls rotary disk to rotate to align the second rotatable member with another one of the fastening rings of the holding device, and controls the second riveting machine to machine the threaded section of the screw of another one of the fastening rings.

3. The device as claimed in claim 1, wherein the holding devices each have a first step, a second step, two lateral sides and two guide plates, the first and second steps are located between the two lateral sides, the first step is higher than the second step, the two guide plates are connected to the two lateral sides, the fastening ting is restricted between the two guide plates and rested on the second step, the screw of the fastening ring is rested on the second step which includes a restriction recess in which a head of the screw is accommodated.

4. The device as claimed in claim 1, wherein the inspection unit includes a first post, a descending member, a control member, a light and a cylinder, the first post includes a fixing member on a top thereof, the descending member and the control member are connected to the fixing member, the descending member is connected to the inspection rod, the control member is electrically connected to the light, the cylinder and the control unit, the inspection rod includes a pre-set travel value from an initial position to a final position where the screw of the fastening ring on the holding device is located, when the cylinder drives the inspection rod downward to travel from the initial position to the final position, and the travel meets the pre-set travel value, the control member sends a normal signal to the control unit and the light emits a first color light, the control unit receives the normal signal and rotates the rotary disk to bring the fastening ring on the holding device to be treated by the first riveting machine and the arm unit, when the cylinder drives the inspection rod downward to travel from the initial position to the final position, and the travel does not meet the pre-set travel value, the control member sends an abnormal signal to the control unit and the light emits a second color light, the control unit receives the abnormal signal and stops the rotary disk.

5. The device as claimed in claim 1, wherein the arm unit includes a second post, a transverse movement member and two claws, the transverse movement member is connected to an upper section of the second post, the two claws are connected to the transverse movement member and located corresponding to one of the holding devices, the control unit controls the two claws to descend and to clamp the two fastening rings on the holding device, the transverse movement member drives the two claws to across the rotary disk and the conveyor, and to release the fastening rings to the conveyor.

6. The device as claimed in claim 5, wherein the control unit controls the two claws to release the two fastening rings in sequence so that the two fastening rings do not hit each other.

7. The device as claimed in claim 1, wherein a classification unit is located at an exit of the conveyor and includes a dispensing disk, an inspection member, a non-defective product area and a defective product area, the dispensing disk accepts the fastening rings, the inspection member is located above the dispensing disk and inspects the fastening rings on the dispensing disk, the fastening rings on the dispensing disk are respectively collected to the non-defective product area and the defective product area.

8. The device as claimed in claim 7, wherein the non-defective product area and the defective product area are located around the dispensing disk and separated from a distance, the classification unit includes a first blowing member and a second blowing member, the first and second blowing members are located above the dispensing disk, the first blowing member faces the non-defective product area, the second blowing member faces tine non-defective product area, the control unit is electrically connected to the dispensing disk, the inspection member, the first blowing member and the second blowing member.

9. The device as claimed in claim 8, wherein the dispensing disk is located below the exit of the conveyor so as to accept the fastening rings drop from the conveyor, the inspection member is a ccd image detector and located above the dispensing disk, the control unit controls the inspection member to take images from the fastening rings on the dispensing disk and to check the screws of the fastening rings, the inspection member sends signals of defective products or signals of non-defective products to the control unit, the control unit controls the first blowing member to blow the fastening rings accompanied with the signals of non-defective product to the non-defective product area, the control unit controls the second blowing member to blow the fastening rings accompanied with the signals of defective product to the defective product area.

10. The device as claimed in claim 9, wherein the defective product area includes a first grade defective product area, a second grade defective product area and a double check area, signals of defective product includes three different signals of defective product sent to the control unit, the control unit controls the second blowing member to respectively blow the fastening rings according to the three signals of defective product to the first grade defective product area, the second grade defective product area and the double check area.
